(19) United States
(12) Patent Application Publication
(10) Pub. No.: US 2004/0177867 A1
(43) Pub. Date: Sep. 16, 2004

(54) Tetra-organic ammonium fluoride and HF in supercritical fluid for photoresist and residue removal

(75) Inventor: Paul E. Schilling, Granite Bay, CA (US)

Correspondence Address: HAVERSTOCK & OWENS LLP, 162 NORTH WOLFE ROAD, SUNNYVALE, CA, 94086, US

(73) Assignee: Supercritical Systems, Inc.

(21) Appl. No.: 10/442,557

(22) Filed: May 20, 2003

Related U.S. Application Data
(63) Continuation-in-part of application No. 10/321,341, filed on Dec. 16, 2002.

(51) Int. Cl. B08B 3/00

(52) U.S. Cl. 134/26

(57) ABSTRACT

A method of removing a material from an oxide surface of a substrate, where the material is selected from the group consisting of photoresist, photoresist residue, etch residue, and a combination thereof, comprises first and second steps. The first step comprises maintaining a supercritical fluid, a carrier solvent, a tetra-organic ammonium fluoride, and HF in contact with the substrate until the material separates from the oxide surface, thereby forming separated material. The second step comprises removing the separated material from the vicinity of the substrate.

### RELATED APPLICATION(S)

This Application is a Continuation-in-part of the Co-pending application Ser. No. 10/321,341, filed Dec. 16, 2002 and entitled “FLUORIDE IN SUPERCRITICAL FLUID FOR PHOTORESIST AND RESIDUE REMOVAL”. The application Ser. No. 10/321,341, filed Dec. 16, 2002 and entitled “FLUORIDE IN SUPERCRITICAL FLUID FOR PHOTORESIST AND RESIDUE REMOVAL” is hereby incorporated by reference.

### FIELD OF THE INVENTION

The present invention relates to the field of removal of photoresist and residue from a substrate. More particularly, the present invention relates to the field of removal of photoresist and residue from a substrate using a supercritical fluid.

### BACKGROUND OF THE INVENTION

Semiconductor fabrication uses photoresist in etching and other processing steps. In the etching steps, the photoresist masks areas of the semiconductor substrate that are not etched. Examples of the other processing steps include using the photoresist to mask areas of a semiconductor substrate in an ion implantation step or using the photoresist as a blanket protective coating of a processed wafer or using the photoresist as the blanket protective coating of a MEMS (micro electromechanical system) device.

Following the etching steps, remaining photoresist exhibits a hardened character that leads to difficulties in the photoresist removal. Following the etching steps, photoresist residue mixed with etch residue coats sidewalls of etch features. Depending on the type of etching step and material etched, the photoresist residue mixed with the etch residue presents a challenging removal problem since the photoresist residue mixed with the etch residue often strongly bond to the sidewalls of the etch features.

Typically, in the prior art, the photoresist and the photoresist residue are removed by plasma ashing in an O₂ plasma followed by stripping in a stripper bath.

FIG. 1 illustrates a first via structure 30 of the prior art subsequent to an RIE (reactive ion etching) etch and prior to a photoresist and residue removal. The first via structure 30 includes a via 32 which is etched into a first SiO₂ layer 34 to a first TiN layer 36. In the first via structure 30, the via 32 stops at the first TiN layer 36 because the first TiN layer 36 provides an etch stop for the RIE etch of the first SiO₂ layer 34. Etching through the first TiN layer 36 complicates the RIE etch by requiring an additional etch chemistry for the first TiN layer 36; so for this particular etch, the TiN layer 36 is not etched. The first TiN layer 36 lies on a first Al layer 38, which lies on a first Ti layer 40. A first residue, which comprises photoresist residue 42 mixed with SiO₂ etch residue 44, coats sidewalls 46 of the via 32. Second photoresist 48 remains on an exposed surface 50 of the first SiO₂ layer 34. In the prior art, the second photoresist 48, the photoresist residue 42, and the SiO₂ etch residue 44 are removed using the plasma ashing and the stripper bath of the prior art. In particular, the stripper bath often employs a fluoride selected from an ammonium fluoride and a hydrofluoric acid, both of which employ water as a carrier solvent.

Note that specific layer materials and specific structure described relative to the first via structure 30, and to other thin film structures discussed herein, are illustrative. Many other layer materials and other structures are commonly employed in semiconductor fabrication.

FIG. 2 illustrates a second via structure 60 of the prior art subsequent to the RIE etch and prior to the photoresist and residue removal. The second via structure 60 includes a second via 62 which is etched through the first SiO₂ layer 34 and the first TiN layer 36 to the first Al layer 38. By etching through the first TiN layer 36, a device performance is improved because a contact resistance with the first Al layer 38 is lower than the contact resistance with the first TiN layer 36. The second via structure 60 also includes the first Ti layer 40. The first residue, which comprises the photoresist residue 42 mixed with the SiO₂ etch residue 44, coats second sidewalls 64 of the second via 62. A second residue, which comprises the photoresist residue 42 mixed with TiN etch residue 66, coats the first residue. The second photoresist 48 remains on the exposed surface 50 of the first SiO₂ layer 34. In the prior art, the second photoresist 48, the photoresist residue 42, the SiO₂ etch residue 44, and the TiN etch residue 66 are removed using the plasma ashing and the stripper bath of the prior art. Unlike the first via structure 30, the stripper bath for the second via structure does not employ the fluoride selected from the ammonium fluoride and the hydrofluoric acid because the fluoride reacts with the first Al layer 38.

Note that the first residue (FIGS. 1 and 2) and the second residue (FIG. 2) are worst case scenarios. Depending upon a specific etch process, the first residue or the second residue might not be present.

FIG. 3 illustrates a metal line structure 70 subsequent to a metal RIE etch and prior to a residue removal. The metal line structure 70 includes a second TiN layer 72 on a second Al layer 74 which is on a second Ti layer 76. The second TiN layer 72, the second Al layer 74, and the second Ti layer 76 form a metal line. The second Ti layer 76 contacts a W via 78, which in turn contacts the first Al layer 38. The W via 78 is separated from the first SiO₂ layer 34 by a sidewall barrier 80. A third residue, which comprises a halogen residue 82 mixed with metal etch residue 84, lies on the exposed surface 50 of the first SiO₂ layer 34. The third residue, which comprises the halogen residue 82 and the metal etch residue 84, also lies on a second exposed surface 86 of the second TiN layer 72. A fourth residue, which comprises a combination of the photoresist residue 42 mixed with metal etch residue 84, coats sides 88 of the metal line. Skirts 90 of the fourth residue extend above the second exposed surface 86 of the second TiN layer 72. In the prior art, the photoresist residue 42, the halogen residue 82, and the metal etch residue 84 are removed using the plasma ashing and the stripper bath of the prior art where the stripper bath employs the fluoride selected from the ammonium fluoride and the hydrofluoric acid.

FIG. 4 illustrates a dual damascene structure 100 of the prior art subsequent to a dual damascene RIE etch and prior to the photoresist and photoresist residue removal. The dual damascene structure 100 includes a dual damascene line 102 formed above a dual damascene via 104. The dual damascene line 102 is etched through a second SiO₂ layer 106 and a first SiN layer 108. The dual damascene via 104 is etched through a third SiO₂ layer 110 and a second SiN layer 112. The dual damascene via is etched to an underlying Cu layer 114.

In processing subsequent to the photoresist and residue removal, exposed surfaces of the dual damascene line and via, 102 and 104, are coated with a barrier layer and then the dual damascene line and via, 102 and 104, are filled with Cu.

Returning to FIG. 4, a fifth residue, which comprises the photoresist residue 42 mixed with the SiO₂ etch residue 44, coats line sidewalls 116 and via sidewalls 118. A sixth residue, which comprises the photoresist residue 42 mixed with SiN etch residue 120, coats the fifth residue. A seventh residue, which comprises the photoresist residue 42 mixed with Cu etch residue 122, coats the sixth residue. The photoresist 48 remains on a second exposed surface of the second SiO₂ layer 106. In the prior art, the photoresist 48, the photoresist residue 42, the SiO₂ etch residue 44, the SiN etch residue 120, and the Cu etch residue 122 are removed by the plasma ashing and the stripper bath of the prior art where the stripper bath employs the fluoride selected from the ammonium fluoride and the hydrofluoric acid.

Note that the fifth, sixth, and seventh residues are worst case scenarios. Depending upon a specific etch process, the fifth, sixth, or seventh residue might not be present.

Recent developments in semiconductor technology have led to proposed replacement of the second and third dielectric layers, 106 and 110, of the dual damascene structure 100 with low dielectric constant materials. Replacing the second and third dielectric layers, 106 and 110, with the low dielectric constant materials enhances an electronic device speed. Current efforts to develop the low dielectric constant materials have led to first and second categories of the low dielectric constant materials. The first category of dielectric materials are spin-on polymers, which are highly cross-linked polymers specifically designed to provide a low dielectric constant. An example of the spin-on polymers is Dow Chemical's SILK®. The second category of low dielectric constant materials are low dielectric constant oxide materials. A first example of the low dielectric constant oxide materials is a C—SiO₂ material in which C (carbon) lowers an SiO₂ dielectric constant. A second example of the low dielectric constant oxide materials is a porous SiO₂ material in which voids in the porous SiO₂ material lower the SiO₂ dielectric constant.

Via and line geometries are progressing to smaller dimensions and larger depth to width ratios. As the via and line geometries progress to the smaller dimensions and larger depth to width ratios, the plasma ashing and the stripper bath of the prior art are becoming less effective at removal of photoresist and photoresist residue. Further, removal of photoresist or residue or photoresist and residue from oxide materials presents a difficult problem because the photoresist and the residue tends to bond strongly to the oxide materials.

What is needed is a more effective and efficient method of removing photoresist and residue from a surface of an oxide material where the photoresist or the residue bonds strongly to the surface of the oxide material.

What is needed is a more effective and efficient method of removing photoresist and residue from a surface of a low dielectric constant oxide material where the photoresist or the residue bonds strongly to the surface of the oxide material.

What is needed is a more effective and efficient method of removing photoresist and residue from an etched surface of an oxide material where the photoresist or the residue bonds strongly to the surface of the oxide material.

What is needed is a more effective and efficient method of removing photoresist and residue from an etched surface of a low dielectric constant oxide material where the photoresist or the residue bonds strongly to the surface of the oxide material.

### SUMMARY OF THE INVENTION

The present invention is a method of removing a material from an oxide surface of a substrate where the material is selected from the group consisting of photoresist, photoresist residue, etch residue, and a combination thereof. The method comprises first and second steps. The first step comprises maintaining a supercritical fluid, a carrier solvent, a tetra-organic ammonium fluoride, and HF in contact with the substrate until the material separates from the oxide surface, thereby forming separated material. The second step comprises removing the separated material from the vicinity of the substrate.

### BRIEF DESCRIPTION OF THE DRAWINGS

FIG. 1 illustrates a first via structure of the prior art subsequent to an RIE etch and prior to a photoresist and residue removal.

FIG. 2 illustrates a second via structure of the prior art subsequent to the RIE etch and prior to the photoresist and residue removal.

FIG. 3 illustrates a metal line structure of the prior art subsequent to the RIE etch and prior to a residue removal.

FIG. 4 illustrates a dual damascene structure of the prior art subsequent to the RIE etch and prior to the photoresist and residue removal.

FIG. 5 is a flow chart illustrating steps of the preferred method of the present invention.

FIG. 6 illustrates the preferred processing system of the present invention.

FIG. 7 is the preferred timeline of the present invention.

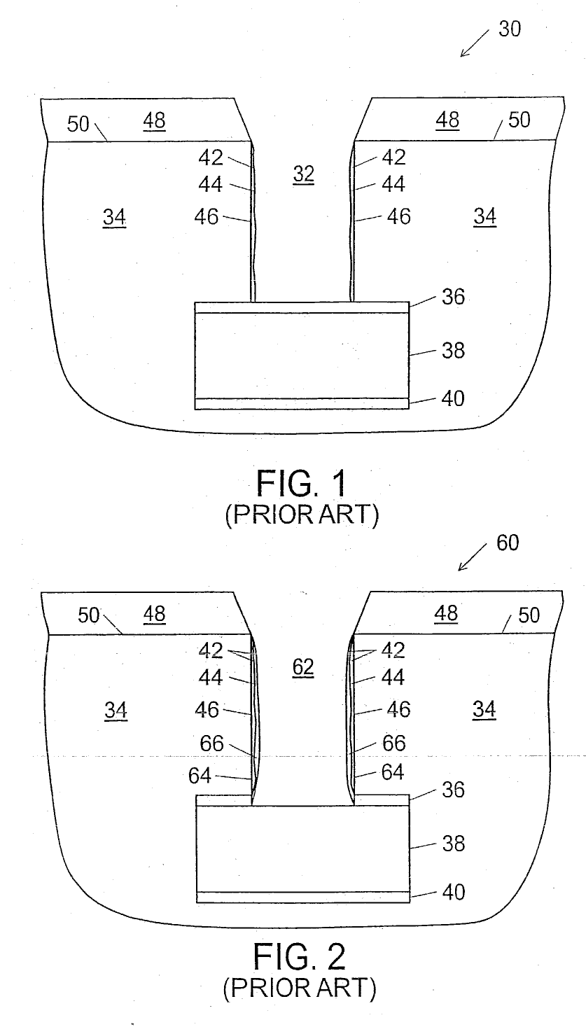

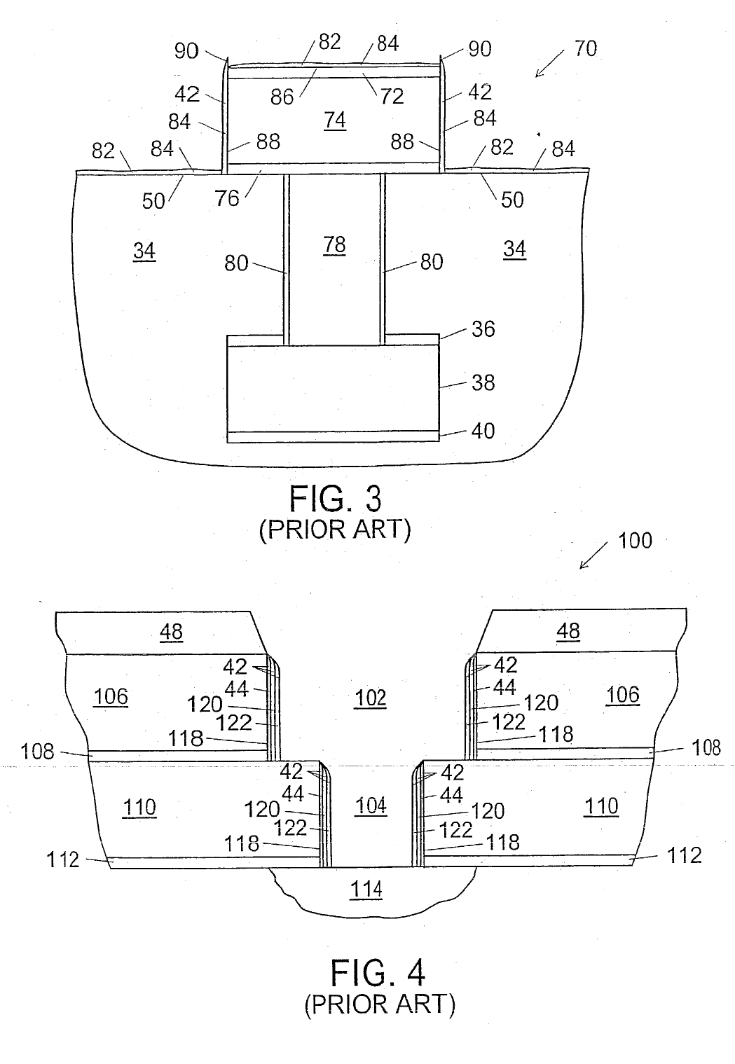

### DETAILED DESCRIPTION OF THE PREFERRED EMBODIMENT

The present invention is a method of removing photoresist and residue from an oxide surface of a substrate using supercritical carbon dioxide, a tetra-organic ammonium fluoride, and HF acid. The residue includes photoresist residue and etch residue. Generally, the substrate is a semiconductor wafer. Alternatively, the substrate is a non-wafer substrate such as a puck. Typically, the photoresist was placed on the wafer to mask a portion of the wafer in a preceding semiconductor fabrication process step such as an etching step.

In the etching step, the photoresist masks areas of the wafer that are not etched while the non-masked regions are etched. In the etching step, the photoresist and the wafer are etched producing etch features while also producing the photoresist residue and the etch residue. Etching of the photoresist produces the photoresist residue. Etching of the etch features produces the etch residue. The photoresist and etch residue generally coat sidewalls of the etch features.

In some etching steps, the photoresist is not etched to completion so that a portion of the photoresist remains on the wafer following the etching step. In these etching steps, the etching process hardens remaining photoresist. In other etching steps, the photoresist is etched to completion so no photoresist remains on the wafer in such etching steps. In the latter case only the residue, that is the photoresist residue and the etch residue, remains on the wafer.

The present invention is preferably directed to removing photoresist for 0.25 micron and smaller geometries. In other words, the present invention is preferably directed to removing I-line exposed photoresists and smaller wavelength exposed photoresists. These are UV, deep UV, and smaller geometry photoresists. Alternatively, the present invention is directed to removing larger geometry photoresists.

It will be readily apparent to one skilled in the art that while the present invention is described in terms of removing the photoresist and the residue it is equally applicable to removing the photoresist and the residue, or to removing the photoresist only, or to removing the residue only.

The preferred embodiment of the present invention removes the photoresist and the residue from the wafer using supercritical carbon dioxide, a tetra-organic ammonium fluoride, HF acid, and a carrier solvent. The tetra-organic ammonium fluoride comprises

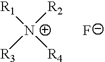

where the R₁, the R₂, the R₃, and the R₄ are preferably selected from the group comprising butyl, methyl, and ethyl. More preferably, the R₁, the R₂, the R₃, and the R₄ are selected from the group comprising butyl and methyl. Most preferably, the R₁, the R₂, the R₃, and the R₄ are butyl. Alternatively, the R₁, the R₂, the R₃, and the R₄ are selected from the group comprising butyl, methyl, ethyl, alkyl, fluoroalkyl, branched alkyl, alkylchloride, alkylbromide, and a combination thereof. Further alternatively, the R₁, the R₂, the R₃, and the R₄ comprise organic radicals which provide favorable solubility in the supercritical carbon dioxide and the carrier solvent.

The carrier solvent is preferably selected from the group comprising N,N-dimethylacetamide (DMAC), gamma-butyrolacetone (BLO), dimethyl sufloxide (DMSO), diethyl carbonate (DEC), propylene carbonate (PC), ethylene carbonate (EC), dimethyl formamide (DMF), propylene, butylene carbonate (PBC), N-methylpyrrolidone (NMP), pyrrolidones having low basicity, other heterocyclic solvents, acetic acid, and a mixture thereof. Most preferably, the carrier solvent is the DMAC. Alternatively, the carrier solvent comprises another solvent providing favorable solubility in the tetra-organic ammonium fluoride and the supercritical carbon dioxide.

The carrier solvent provides a solution for injecting the tetra-organic ammonium fluoride and the HF acid into the supercritical carbon dioxide, though, the carrier solvent is not limited to this function. In addition to carrying the tetra-organic ammonium fluoride and the HF acid into the supercritical carbon dioxide, the carrier solvent preferably assists in dissolving the photoresist and residue, or dissolving the photoresist, or dissolving the residue. Alternatively, the carrier solvent does not assist in dissolving the photoresist or the residue.

In the present invention, the tetra-organic ammonium fluoride and HF acid provide a controllable mechanism for introducing HF₂⊖ ions to the oxide surface, which bears the photoresist and the residue. The HF₂⊖ ions dissolve a small amount of the oxide surface, typically a monolayer, causing the photoresist and the residue to separate from the oxide surface. The photoresist and the residue is then carried away from the oxide surface.

If no HF acid is used, the tetra-organic ammonium fluoride provides a controllable mechanism for introducing F⊖ ions. By adding the HF acid, the HF₂⊖ ions are produced which dissolve the oxide surface at a faster rate than the F⊖ ions. This faster rate is typically on an order of twenty times faster. Thus, if the photoresist or the residue is strongly bonded to the oxide surface, the HF₂⊖ ions reduce a time period needed to separate the photoresist or the residue from the from the oxide surface.

Preferably in the present invention, water concentration is limited to an acceptable amount. This allows a concentration of the HF₂⊖ ions to be controlled in proportion to an amount of the tetra-organic ammonium fluoride and HF acid that is present. If the water concentration significantly exceeds the acceptable amount, controllability of the concentration of the HF₂⊖ ions is reduced because the HF₂⊖ ions and the water create an equilibrium of hydrous HF₂⊖ ions, which reduces the HF₂⊖ ions carried to the oxide surface since the water and the hydrous HF₂⊖ ions have poor solubility in the supercritical carbon dioxide.

Use of the tetra-organic ammonium fluoride provides advantages over use of ammonium fluoride. The tetra-organic ammonium fluoride is soluble in low polarity solvents, such as the carrier solvent and the supercritical carbon dioxide, as opposed to the ammonium fluoride which is soluble in a polar solvent, such as water. The solubility of the tetra-organic ammonium fluoride in the low polarity solvent allows the carrier solvent to readily carry the tetra-organic ammonium fluoride into the supercritical carbon dioxide. This also allows the supercritical carbon dioxide to readily carry the tetra-organic ammonium fluoride to the oxide surface of the semiconductor substrate. In contrast, ammonium fluoride would typically be carried into the supercritical carbon dioxide using water. Further, agitation would be required to carry the ammonium fluoride to the oxide surface of the semiconductor substrate because of the poor solubility of the ammonium fluoride in the supercritical carbon dioxide. Moreover, the water itself presents a problem because it causes an equilibrium to form between NH₃ and HF, which makes it difficult to control the concentration of the HF₂⊖ ions.

The oxide surface from which the photoresist or the residue or the photoresist and the residue is removed comprises an oxide material. Preferably, the oxide material is selected from the group comprising SiO₂, MSQ (methyl silsequioxane), HSQ (hydrogen silsequioxane), FSG (fluorinated silicate glass), PSG (phosphor silicate glass), BPSG (boron phosphor silicate glass), other silicate glasses, and Al₂O₃. Alternatively, the oxide material comprises a material that is etched by HF₂⊖ ions. Further alternatively, the oxide material comprises a porous oxide material. However, since voids in the porous oxide material increase the porous oxide material's surface area, it is anticipated that the HF₂⊖ ions could remove an unacceptable amount of the porous oxide material.

In a first alternative embodiment of the present invention, an organic acid is added to the combination of the supercritical carbon dioxide, the tetra-organic ammonium fluoride, the HF acid, and the carrier solvent. In the first alternative embodiment of the present invention, the organic acid functions as a buffering agent.

In a second alternative embodiment of the present invention, a photoresist solvent is added to the combination of the supercritical carbon dioxide, the tetra-organic ammonium fluoride, and the carrier solvent. The carrier solvent preferably comprises one or more solvents selected from the group of N,N-dimethylacetamide (DMAC), gamma-butyrolacetone (BLO), dimethyl sufloxide (DMSO), diethyl carbonate (DEC), propylene carbonate (PC), ethylene carbonate (EC), dimethyl formamide (DMF), propylene, butylene carbonate (PBC), N-methylpyrrolidone (NMP), pyrrolidones having low basicity, other heterocyclic solvents and acetic acid.

In a third alternative embodiment of the present invention, a residue solvent is added to the combination of the supercritical carbon dioxide, the tetra-organic ammonium fluoride, HF acid, and the carrier solvent. The carrier solvent preferably comprises one or more solvents selected from the group of N,N-dimethylacetamide (DMAC), gamma-butyrolacetone (BLO), dimethyl sufloxide (DMSO), diethyl carbonate (DEC), propylene carbonate (PC), ethylene carbonate (EC), dimethyl form amide (DMF), propylene, butylene carbonate (PBC), N-methylpyrrolidone (NMP), pyrrolidones having low basicity, other heterocyclic solvents and acetic acid.

In a fourth alternative embodiment of the present invention, the HF acid is replaced by HF gas. In the fourth alternative embodiment, the carrier solvent carries the tetra-organic ammonium fluoride into the supercritical fluid. The HF gas is preferably injected into the supercritical fluid separately. Alternatively, the HF gas is injected into the carrier solvent, which carries the HF gas into the supercritical fluid.

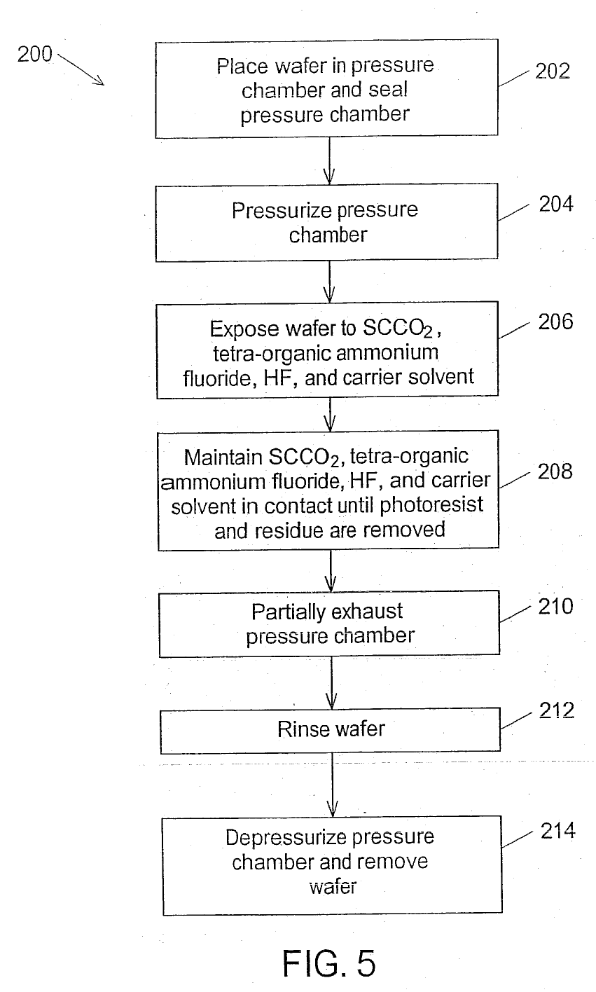

The preferred method of the present invention is illustrated as a block diagram in FIG. 5. The preferred method 200 begins by placing a wafer, with the photoresist and the residue on the oxide surface of the wafer, within a pressure chamber and sealing the pressure chamber in a first process step 202. In a second process step 204, the pressure chamber is pressurized with carbon dioxide until the carbon dioxide becomes the supercritical carbon dioxide (SCCO₂). In a third process step 206, the supercritical carbon dioxide carries the tetra-organic ammonium fluoride and the carrier solvent into the process chamber.

In a fourth process step 208, the supercritical carbon dioxide, the tetra-organic ammonium fluoride, and the carrier solvent are maintained in contact with the wafer until the photoresist and the residue are removed from the oxide surface of the wafer. In the fourth process step 208, the carrier solvent at least partially dissolves the photoresist and the residue. Alternatively in the fourth process step 208, the photoresist solvent at least partially dissolves the photoresist. Further alternatively in the fourth process step 208, the residue solvent at least partially dissolves the residue.

In a fifth process step 210, the pressure chamber is partially exhausted. In a sixth process step 212, the wafer is rinsed. In a seventh process step 214, the preferred method 200 ends by depressurizing the pressure chamber and removing the wafer.

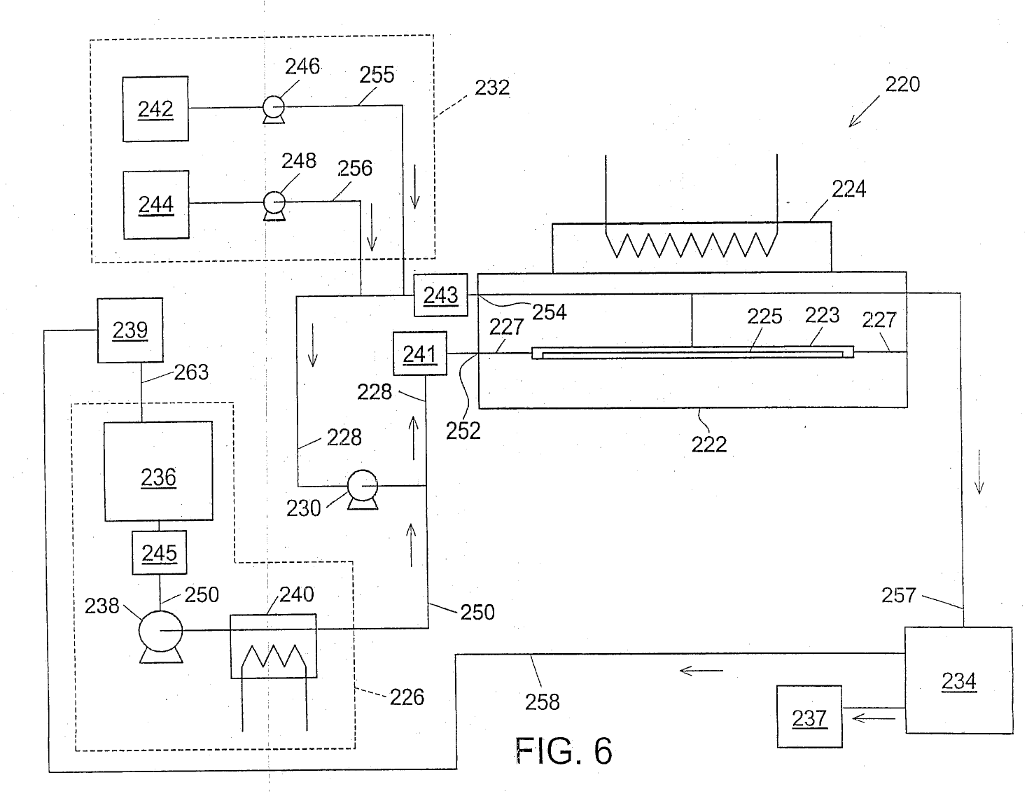

The preferred supercritical processing system of the present invention is illustrated in FIG. 6. The preferred supercritical processing system 220 comprises the pressure chamber 222, a pressure chamber heater 224, a carbon dioxide supply arrangement 226, a circulation loop 228, a circulation pump 230, a chemical agent and rinse agent supply arrangement 232, a separating vessel 234, a liquid/solid waste collection vessel 237, and a liquefying/purifying arrangement 239. The pressure chamber 222 provides a wafer cavity 223 for the wafer 225. The chamber housing further comprises injection nozzles 227.

The carbon dioxide supply arrangement 236 comprises a carbon dioxide supply vessel 236, a carbon dioxide pump 238, and a carbon dioxide heater 240. The chemical agent and rinse agent supply arrangement 232 comprises a chemical supply vessel 242, a rinse agent supply vessel 244, and first and second high pressure injection pumps, 246 and 248.

The carbon dioxide supply vessel 236 is coupled to the pressure chamber 222 via the carbon dioxide pump 238 and carbon dioxide piping 250. The carbon dioxide piping 250 includes the carbon dioxide heater 240 located between the carbon dioxide pump 238 and the pressure chamber 222. The pressure chamber heater 224 is coupled to the pressure chamber 222. The circulation pump 230 is located on the circulation loop 228. The circulation loop 228 couples to the pressure chamber 222 at a circulation inlet 252 and at a circulation outlet 254. The chemical supply vessel 242 is coupled to the circulation loop 228 via a chemical supply line 255. The rinse agent supply vessel 244 is coupled to the circulation loop 228 via a rinse agent supply line 256. The separating vessel 234 is coupled to the pressure chamber 222 via exhaust gas piping 257. The liquid/solid waste collection vessel 237 is coupled to the separating vessel 234.

The separating vessel 234 is preferably coupled to the liquefying/purifying arrangement 239 via return gas piping 258. The liquefying/purifying arrangement 239 is preferably coupled to the carbon dioxide supply vessel 236 via liquid carbon dioxide piping 263. Alternatively, an off-site location houses the liquefying/purifying arrangement 239, which receives exhaust gas in gas collection vessels and returns liquid carbon dioxide in liquid carbon dioxide vessels.

The pressure chamber heater 224 heats the pressure chamber 222. Preferably, the pressure chamber heater 224 is a heating blanket. Alternatively, the pressure chamber heater is some other type of heater.

Preferably, first and second filters, 241 and 243, are coupled to the circulation loop 228. Preferably, the first filter 241 comprises a fine filter. More preferably, the first filter 241 comprises the fine filter configured to filter 0.05 μm and larger particles. Preferably, the second filter 243 comprises a coarse filter. More preferably, the second filter 243 comprises the coarse filter configured to filter 2-3 μm and larger particles. Preferably, a third filter 245 couples the carbon dioxide supply vessel 236 to the carbon dioxide pump 238. Preferably, the third filter 245 comprises the fine filter. More preferably, the third filter 245 comprises the fine filter configured to filter the 0.05 μm and larger particles.

It will be readily apparent to one skilled in the art that the supercritical processing system 220 includes valving, control electronics, and utility hookups which are typical of supercritical fluid processing systems.

A first alternative supercritical processing system of the present invention is described in U.S. patent application Ser. No. 09/912,844, filed on Jul. 24, 2001, and entitled “High Pressure Processing Chamber for Semiconductor Substrate,” which is incorporated by reference in its entirety.

Referring to both FIGS. 5 and 6, implementation of the preferred method 200 begins with the first process step 202, in which the wafer 225, having the photoresist or the residue or both the photoresist and the residue on the oxide surface of the wafer 225, is placed in the wafer cavity 223 of the pressure chamber 222 and, then, the pressure chamber 222 is sealed. In the second process step 204, the pressure chamber 222 is pressurized by the carbon dioxide pump 238 with the carbon dioxide from the carbon dioxide supply vessel 236. During the second step 204, the carbon dioxide is heated by the carbon dioxide heater 240 while the pressure chamber 222 is heated by the pressure chamber heater 240 to ensure that a temperature of the carbon dioxide in the pressure chamber 222 is above a critical temperature. The critical temperature for the carbon dioxide is 31° C. Preferably, the temperature of the carbon dioxide in the pressure chamber 222 is within a range of 45° C. to 75° C. Alternatively, the temperature of the carbon dioxide in the pressure chamber 222 is maintained within a range of from 31° C. to about 100° C. Further alternatively, the carbon dioxide in the pressure chamber 222 is maintained at or above 31° C.

Upon reaching initial supercritical conditions, the first injection pump 246 pumps the tetra-organic ammonium fluoride and the carrier solvent from the chemical supply vessel 242 into the pressure chamber 222 via the circulation loop 228 while the carbon dioxide pump 238 further pressurizes the supercritical carbon dioxide in the third process step 206. Once a desired amount of the tetra-organic ammonium fluoride and the carrier solvent has been pumped into the pressure chamber 222 and desired supercritical conditions are reached, the carbon dioxide pump 238 stops pressurizing the pressure chamber 222, the first injection pump 246 stops pumping the tetra-organic ammonium fluoride and the, carrier solvent into the pressure chamber 222, and the circulation pump 230 begins circulating the supercritical carbon dioxide, the tetra-organic ammonium fluoride, and the carrier solvent in the fourth process step 208. By circulating the supercritical carbon dioxide, the tetra-organic ammonium fluoride, and the carrier solvent, the supercritical carbon dioxide maintains the tetra-organic ammonium fluoride, and the carrier, solvent in contact with the wafer. Additionally, by circulating the supercritical carbon dioxide, the tetra-organic ammonium fluoride, and the carrier solvent, a fluid flow enhances removal of the photoresist and the residue from the wafer.

Preferably, the wafer 225 is held stationary in the pressure chamber 222 during the fourth process step 208. Preferably, the injection nozzles 227 create a vortex within the wafer cavity 223 in order to enhance the removal of the photoresist and the residue.

After the photoresist and the residue has been removed from the wafer 225, the pressure chamber 222 is partially depressurized by exhausting some of the supercritical carbon dioxide, the tetra-organic ammonium fluoride, the carrier solvent, removed photoresist, and removed residue to the exhaust gas separating vessel 234 in order to return conditions in the pressure chamber 222 to near the initial supercritical conditions in the fifth process step 210.

In the sixth process step 212, the second injection pump 248 pumps a rinse agent from the rinse agent supply vessel 244 into the pressure chamber 222 via the circulation loop 228 while the carbon dioxide pump 238 pressurizes the pressure chamber 222 to near the desired supercritical conditions and, then, the circulation pump 230 circulates the supercritical carbon dioxide and the rinse agent in order to rinse the wafer. Preferably, the rinse agent is selected from the group consisting of water, alcohol, acetone, and a mixture thereof. More preferably, the rinse agent is the mixture of the alcohol and the water. Preferably, the alcohol is selected from the group consisting of isopropyl alcohol, ethanol, and other low molecular weight alcohols. More preferably, the alcohol is selected from the group consisting of the isopropyl alcohol and the ethanol. Most preferably, the alcohol is the ethanol.

In the seventh process step 214, the pressure chamber 222 is depressurized, by exhausting the pressure chamber 222 to the separating vessel 234 and, finally, the wafer is removed from the pressure chamber 222.

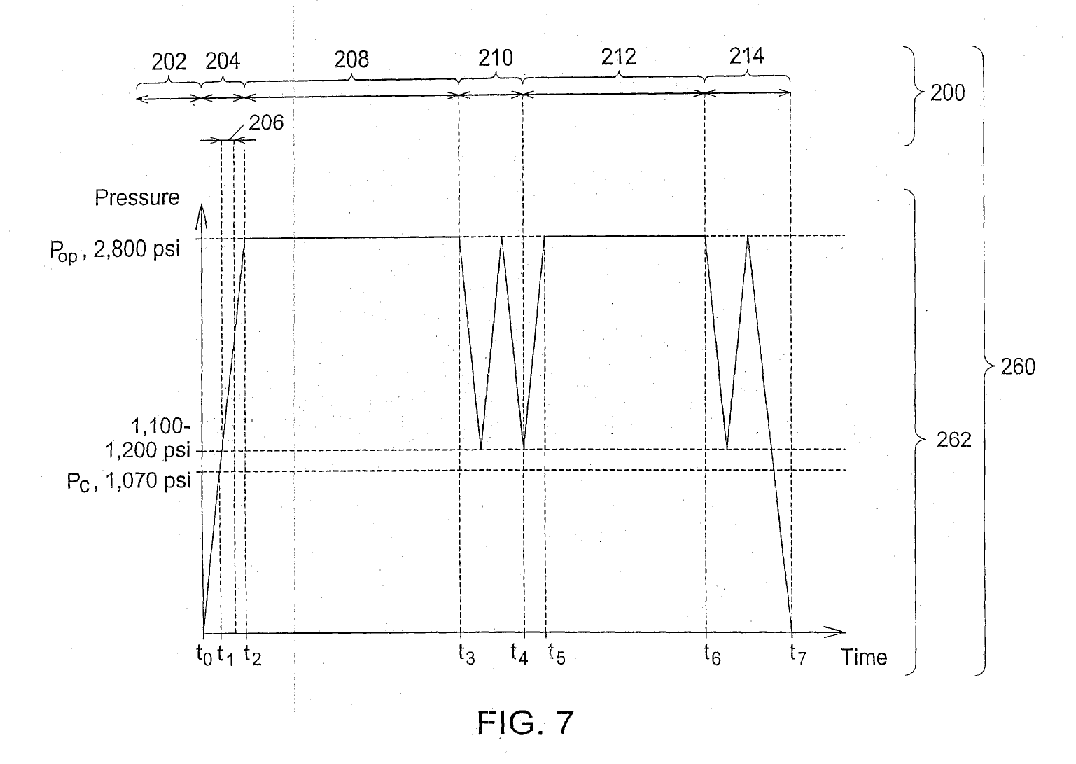

The preferred timeline of the present invention is graphically illustrated in FIG. 7. The preferred timeline 260 indicates the preferred method 200 as a function of time and also indicates pressure 262 as a function of the time. It will be readily apparent to one skilled in the art that the time axis in FIG. 8 is only illustrative and as such does not indicate relative time periods to scale. Ideally, of course, all times would be minimized within reason to obtain an economical and efficient processing method.

Prior to an initial time t₀, the wafer is placed within the pressure chamber 222 and the pressure chamber 222 is sealed in the first process step 202. From the initial time to through a first time t₁ to a second time t₂, the pressure chamber 222 is pressurized in the second process step 204. The pressure chamber reaches critical pressure P_{c} at the first time t₁. The critical pressure P_{c} for the supercritical carbon dioxide is 1,070 psi. Preferably, the tetra-organic ammonium fluoride and the carrier solvent are injected into the pressure chamber 222 between the first time t₁ and the second time t₂ in the third process step 206. Preferably, an tetra-organic ammonium fluoride and carrier solvent injection begins upon reaching about 1100-1200 psi. Alternatively, the tetra-organic ammonium fluoride and the carrier solvent are injected into the pressure chamber around the second time t₂ or after the second time t₂. The pressure chamber reaches an operating pressure Pₒₚ at the second time t₂. Preferably, the operating pressure Pₒₚ is about 2,800 psi. Alternatively, the operating pressure Pₒₚ is within the range of from 1,070 psi to about 6,000 psi.

The preferred timeline 260 continues in the fourth process step 208 with maintaining the supercritical carbon dioxide, the tetra-organic ammonium fluoride, and the carrier solvent in contact with the wafer until the photoresist and the residue are removed from the oxide surface of the wafer, which takes place from the second time t₂ to a third time t₃. In the fifth process step 210, the pressure chamber 226 is partially exhausted from the third time t₃ to a fourth time t₄. Preferably, this is accomplished by dropping from the operating pressure Pₒₚ to about the 1,100-1,200 psi in a first exhaust, raising from the 1,100-1,200 psi to the operating pressure Pₒₚ in a first pressure recharge, and dropping again to the 1,100-1,200 psi in a second exhaust. Alternatively, the pressure recharge and the second exhaust are not performed as part of the fifth process step 210. Further alternatively, additional recharges and exhausts are performed as part of the fifth process step 210 where one or more of the exhausts can be a full exhaust.

The preferred timeline 260 continues in the sixth process step 212 with rinsing of the wafer from the fourth time t₄ through a fifth time t₅ to a sixth time t₆. The sixth process step 212 begins with a second pressure recharge during which the rinse agent is preferably injected into the pressure chamber 226 from the fourth time t₄ to the fifth time t₅. In the seventh process step 214, the pressure chamber 226 is exhausted from the sixth time t₆ to a seventh time t₇. Preferably, this is accomplished by dropping the operating pressure Pₒₚ to about the 1,100-1,200 psi in a third exhaust, raising from the 1,100-1,200 psi to the operating pressure Pₒₚ in a third pressure recharge, and finally dropping to atmospheric pressure in a final exhaust. Alternatively, the third exhaust and the third pressure recharge are not performed as part of the seventh process step 214. Further alternatively, additional exhausts and recharges are performed as part of the seventh process step 210.

In a first alternative timeline, the fourth process step 208 is performed at an initial cleaning pressure and a final cleaning pressure. Preferably, the initial cleaning pressure is about the 1,100-1,200 psi and the final cleaning pressure is about the 2,800 psi. At the initial cleaning pressure, a first solubility of some of the chemicals is lower than a second solubility at the final cleaning pressure. During an initial cleaning phase which takes place at the initial cleaning pressure, lower solubility chemicals condense on the wafer. This provides greater concentration of the lower solubility chemicals on the photoresist and the residue and, thus, enhances separation of the photoresist and the residue from the wafer. During a final cleaning phase which takes place at the final cleaning pressure, the lower solubility chemicals either no longer condense or condense less on the wafer and, thus, concentration of the lower solubility chemicals on the wafer is reduced in anticipation of finishing the fourth process step 208.

In a second alternative timeline of the present invention, a second rinse is performed after performing the first rinse.

### Specific Embodiments

First through ? specific embodiments of the present invention are discussed below. Each of the first through ? specific embodiments is a summary of a specific chemistry and a specific method employed in a lab system, similar to the preferred supercritical processing system 220. The lab system was used to remove the photoresist, or to remove the photoresist and the residue, or to remove the residue from test wafers. The lab system featured a combined internal volume for the pressure chamber 226, the circulation pump 230, and the circulation line 242 of about ?? liters. The first through ? specific embodiments were performed as part of a proof-of-concept feasibility study intended to show feasibility of the present invention for use in semiconductor fabrication. Before an incorporation of the present invention in the semiconductor fabrication, it is envisioned that further process refinements would be made.

1. A method of processing a substrate comprising the steps of:
a. maintaining a supercritical fluid, a carrier solvent, a tetra-organic ammonium fluoride, and HF in contact with the substrate, the substrate comprising an oxide surface which supports a material selected from the group consisting of photoresist, photoresist residue, etch residue, and a combination thereof, the supercritical fluid, the carrier solvent, and the quaternary ammonium fluoride maintained in contact with the substrate until the material separates from the oxide surface, thereby forming separated material; and
b. removing the separated material from the vicinity of the substrate.

2. The method of claim 1 wherein the supercritical fluid comprises supercritical carbon dioxide.

3. The method of claim 1 wherein the carrier solvent is selected from the group consisting N,N-dimethylacetamide (DMAC), gamma-butyrolacetone (BLO), dimethyl sufloxide (DMSO), diethyl carbonate (DEC), propylene carbonate (PC), ethylene carbonate (EC), dimethyl formamide (DMF), propylene, butylene carbonate (PBC), N-methylpyrrolidone (NMP), pyrrolidones, heterocyclic solvents, acetic acid, and a mixture thereof.

4. The method of claim 3 wherein the carrier solvent comprises the DMAC.

5. The method of claim 1 wherein the tetra-organic ammonium fluoride comprises

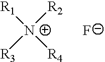

6. The method of claim 5 wherein the R₁, the R₂, the R₃, and the R₄ are selected from the group consisting of butyl, methyl, ethyl, alkyl, fluoroalkyl, branched alkyl, alkylchloride, alkylbromide, and a combination thereof.

7. The method of claim 6 wherein the R₁, the R₂, the R₃, and the R₄ are selected from the group consisting of the butyl, the methyl, the ethyl, and a combination thereof.

8. The method of claim 7 wherein the R₁, the R₂, the R₃, and the R₄ are selected from the group consisting of the butyl, the methyl, and a combination thereof.

9. The method of claim 8 wherein the R₁ the R₂, the R₃, and the R₄ are the butyl.

10. The method of claim 1 further comprising the step of introducing the HF to the supercritical fluid as HF acid.

11. The method of claim 1 wherein the oxide comprises silicon dioxide.

12. The method of claim 1 wherein the oxide comprises aluminum oxide.

13. The method of claim 1 wherein the oxide comprises a low dielectric constant oxide.

14. The method of claim 13 wherein the low dielectric constant oxide comprises a carbon containing oxide material.

15. The method of claim 14 wherein the low dielectric constant material comprises a C—SiO₂ material.

16. The method of claim 13 wherein the low dielectric constant oxide comprises a porous oxide material.

17. The method of claim 16 wherein the low dielectric constant material comprises a porous SiO₂ material.

18. The method of claim 1 wherein the step of removing the separated material from the vicinity of the substrate comprises flowing supercritical fluid over the substrate.

19. The method of claim 1 further comprising the step of rinsing the substrate in the supercritical carbon dioxide and a rinse agent.

20. The method of claim 19 wherein the rinse agent comprises water.

21. The method of claim 19 wherein the rinse agent comprises alcohol.

22. The method of claim 21 wherein the alcohol comprises ethanol.

23. The method of claim 19 wherein the rinse agent comprises acetone.

24. A method of removing a material from an oxide surface, the material selected from the group consisting of photoresist, photoresist residue, etch residue, and a combination thereof, the method comprising the steps of:
a. maintaining a supercritical fluid, a carrier solvent, a tetra-alkyl ammonium fluoride, and HF in contact with the oxide surface until the material separates from the oxide surface, thereby forming separated material; and
b. removing the separated material from the vicinity of the substrate.

25. A method of removing a material from an oxide surface, the material selected from the group consisting of photoresist, photoresist residue, etch residue, and a combination thereof, the method comprising the steps of:
a. maintaining a supercritical fluid, a carrier solvent, a tetra-butyl ammonium fluoride, and HF in contact with the oxide surface until the material separates from the oxide surface, thereby forming separated material; and
b. removing the separated material from the vicinity of the substrate.
